(19) United States
(12) Patent Application Publication
(10) Pub. No.: US 2023/0342618 A1
(43) Pub. Date: Oct. 26, 2023

(54) IDENTIFYING IDLE PROCESSORS USING NON-INTRUSIVE TECHNIQUES

(71) Applicant: NVIDIA Corporation, Santa Clara, CA (US)

(72) Inventors: Yogesh Dangi, Pune (IN); Manas Ranjan Jagadev, San Jose, CA (US); Doru Carastan, San Jose, CA (US)

(21) Appl. No.: 17/722,233

(22) Filed: Apr. 15, 2022

(51) Int. Cl. G06N 3/08

(52) U.S. Cl. CPC G06N 3/088

(57) ABSTRACT

Apparatuses, systems, and techniques to classify computing devices as idle or busy using a machine learning (ML) model based on power consumption data collected non-intrusively are described. One method receives power consumption data for a computing device from a service processor operatively coupled to the computing device. The method determines a set of features from the power consumption data for a first time period. The method classifies, using an ML model and the set of features, whether the computing device is idle or busy in the first time period. The method outputs an indication of the computing device being idle responsive to a classification that the computing device is idle.

### TECHNICAL FIELD

At least one embodiment pertains to processing resources used to perform and facilitate artificial intelligence. For example, at least one embodiment pertains to processors or computing systems used to train and use neural networks to identify idle computing devices using non-intrusive techniques according to various novel techniques described herein.

### BACKGROUND

In multi-computing platforms and environments - such as data centers, supercomputers, high performance computing (HPC) environments, cluster computing environments, or cloud computing environments, etc. -- it is important to find idle or underutilized computing devices so that the usages of these computing devices can be more efficiently allocated by taking corrective actions. Existing solutions are considered intrusive solutions because they require an agent or process to run within an operating system (OS) of a computing device to collect metric information -- such as central processing unit (CPU) usage, Memory usage, and I/O usage - that is then sent to other systems for analysis over a primary network connection. Such intrusive solutions cause system overhead by running an extra agent or program within the OS and consuming bandwidth and resources on the primary network connection to send the metric information to the other systems. Also, there are risks of the existing solutions not working since the agent or process can be terminated or stopped by administrative users that may not want any such overhead.

### BRIEF DESCRIPTION OF DRAWINGS

Various embodiments in accordance with the present disclosure will be described with reference to the drawings, in which:

FIG. 1A is a block diagram of an idle-device identification system for identifying idle computing devices in an exemplary data center, according to at least one embodiment.

FIG. 1B is a block diagram of an idle-device identification system for collecting power information non-intrusively from a data center, according to at least one embodiment.

FIG. 2 is an example data flow diagram of a process for identifying idle computing devices, according to at least one embodiment.

FIG. 3 illustrates an example user interface (UI) dashboard, according to at least one embodiment.

FIG. 4 illustrates training and deployment of a neural network, according to at least one embodiment.

FIG. 5 is a flow diagram of a method of identifying idle computing devices, according to at least one embodiment.

FIG. 6 is a flow diagram of a method of training a machine learning (ML) model for classifying a computing device as idle or busy, according to at least one embodiment.

FIG. 7A illustrates inference and/or training logic, according to at least one embodiment.

FIG. 7B illustrates inference and/or training logic, according to at least one embodiment.

FIG. 8 illustrates an example data center system, according to at least one embodiment.

FIG. 9 illustrates a computer system, according to at least one embodiment.

FIG. 10 illustrates a computer system, according to at least one embodiment.

FIG. 11 illustrates at least portions of a graphics processor, according to one or more embodiments.

FIG. 12 illustrates at least portions of a graphics processor, according to one or more embodiments.

FIG. 13 is an example data flow diagram for an advanced computing pipeline, in accordance with at least one embodiment.

FIG. 14 is a system diagram for an example system for training, adapting, instantiating, and deploying machine learning models in an advanced computing pipeline, in accordance with at least one embodiment.

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

### Idle-Device Identification Systems

Embodiments described herein are directed to determining idle computing devices using a non-intrusive approach. The computing devices can be CPUs, graphics processing units (GPUs), data processing units (DPUs), or the like. These computing devices can also be implemented as components in devices referred to as machines, computers, servers, network devices, or the like. These computing devices are important resources in a data center or a cloud environment. It is important to have efficient and effective monitoring or management of these resources. As described above, it is important to identify idle or under-utilized computing so that the usages of these computing devices can be enhanced by taking corrective actions. Conventional solutions are intrusive because they require an agent or process to run within an OS of a computing device to collect metric information, such as CPU usage, Memory usage, and I/O usage, and send the metric information to other systems for analysis over a primary network connection. Conventional solutions cause system overhead by running an extra agent or program within the OS (which can be intrusive) and consuming bandwidth and resources on the primary network connection to send the metric information to the other systems. Conventional solutions can also be terminated or stopped by administrator users.

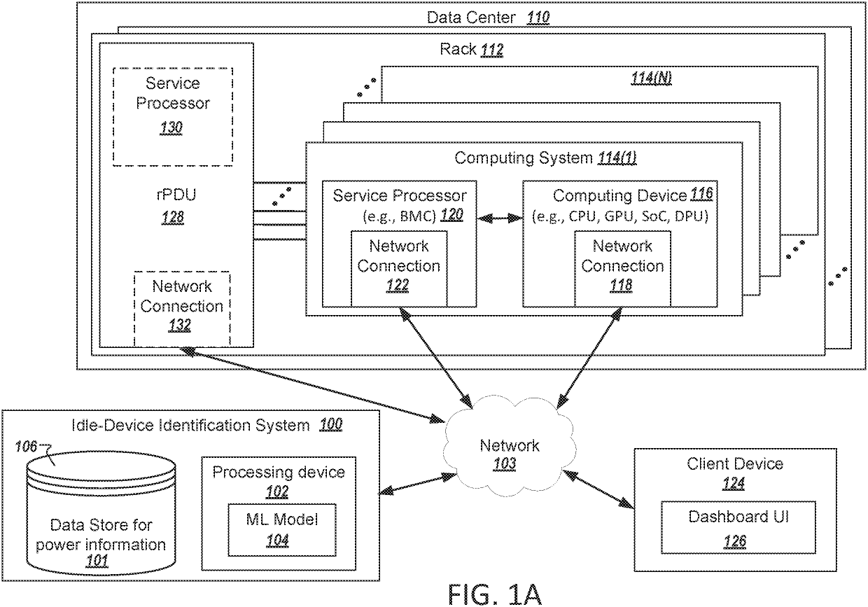

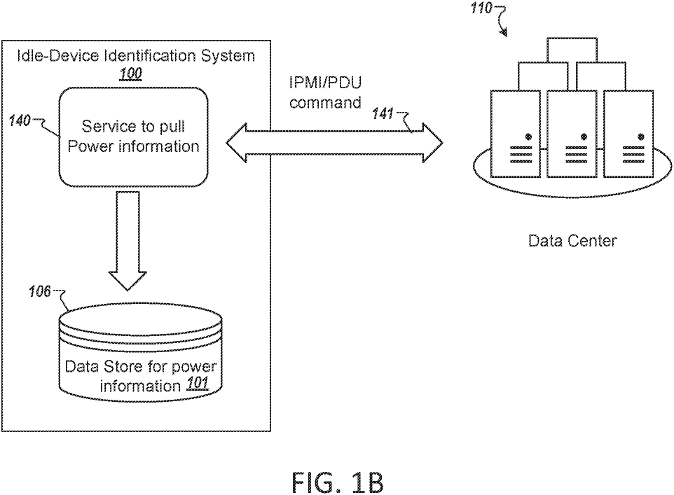

Aspects and embodiments of the present disclosure address these and other challenges by providing a non-intrusive approach for identifying idle or underutilized computing devices. Aspects and embodiments of the present disclosure can analyze power consumed by the computing devices and predict whether computing devices are idle or underutilized based on the power consumed. Aspects and embodiments of the present disclosure can obtain power consumption information from a service processor, such as a baseboard management controller (BMC) or a rack power distribution unit (rPDU), with out-of-band functionality, and store the power consumption information in a database. The service processor can provide out-of-band functionality by collecting the power consumption information of a computing device independently from a host’s CPU, firmware, and OS, and providing the power consumption information via a network connection independent from a primary network connection of the computing device. Aspects and embodiments of the present disclosure can use the power consumption information in the database to train an ML model to classify a computing device as idle or busy based on features extracted from the power consumption information. Aspects and embodiments of the present disclosure can use machine learning to identify various hidden patterns in the power consumption information and use the patterns of the power consumption information to determine if a computing device is idle or busy. For example, the hidden patterns can include a scenario where a computing system with a CPU and a GPU is considered idle by an operating system and still consuming a lot of power or a scenario where the computing system is considered busy and does not consume a lot of power. Aspects and embodiments of the present disclosure can leverage Intelligent Platform Management Interface (IPMI) technology to collect power consumption information non-intrusively from the computing devices, and the analysis and processing of the computer consumption information take place outside of the operating systems of these computing devices. Aspects and embodiments of the present disclosure do not cause the overhead of running the agent or process within the OS. Aspects and embodiments of the present disclosure do not include the risk of the agent or process being terminated or stopped by administrators. Aspects and embodiments of the present disclosure, instead of collecting metric information in an intrusive way by an agent or process in the OS, can collect power consumption information non-intrusively from a computing device that is determined to be idle using machine learning, as described in more detail below with respect to FIGS. 1-6.

FIG. 1A is a block diagram of an idle-device identification system 100 for identifying idle computing devices in an exemplary data center, according to at least one embodiment. The idle-device identification system 100 includes a processing device 102 that executes an ML model 104 trained to identify idle or underutilized computing devices in a non-intrusive approach. The processing device 102 can analyze power consumption data 101 (e.g., power consumed metrics) stored in a data store 106 (e.g., database) and predict whether computing devices are idle or underutilized based on the power consumption data 101. The idle-device identification system 100 can be coupled to a data center 110 over a network 103.

The data center 110 can include a rack 112 of one or more computing systems 114(1)-114(N), where N is a positive integer equal to or greater than zero. Each computing system 114 can include a computing device 116 and a service processor 120. In at least one embodiment, the service processor 120 is a baseboard management controller (BMC). The BMC can be part of an IPMI type interface and can be located on a circuit board (e.g., motherboard) of the computing device 116 being monitored. The BMC can include one or more sensors that are operatively coupled to the computing device 116 or integrated within the computing device 116. The sensors of a BMC measure internal physical variables such as temperature, humidity, power-supply voltage, fan speeds, communications parameters, and operating system (OS) functions. The BMC can provide a way to manage a computer that may be powered off or otherwise unresponsive. The service processor 120 provides out-of-band functionality by collecting the power consumption data of the computing device 116 independently from the computing device’s CPU, firmware, and OS. The service processor 120 can provide the power consumption data via a network connection 122 independent from a primary network connection 118 of the computing device 116. The service processor 120 can use the network connection 122 to the hardware itself rather than the OS or login shell to manage the computing device 116, even if the computing device 116 is powered off or otherwise unresponsive.

In at least one embodiment, the processing device 102 can receive power consumption data 101 for the computing device 116 from the service processor 120 operatively coupled to the computing device 116. The processing device 102 can store the power consumption data in the data store 106. The processing device 102 can determine a set of features from the power consumption data 101 for a first time period. The processing device 102 can classify whether the computing device 116 is idle (or underutilized) or busy in the first time period using the ML model 104 and the set of features. The processing device 102 can output an indication of the computing device 116 being idle, responsive to a classification that the computing device 116 is idle. The processing device 102 can send the idle indication to a client device 124, such as to be displayed on a user interface (UI) dashboard 126. In at least one embodiment, the indication can include a list of idle computing devices for a previous day, a list of continuous idle computing devices for a last N number of days, a list of idle computing devices for a given data range, or the like. In another embodiment, the indication can be merely a status for a given device identifier of the computing device. In at least one embodiment, an administrator can specify a device name and a date (or date range), and the idle-device identification system 100 can indicate whether the computing device, corresponding to the device name, is classified as idle or not for the specified data (or data range).

In at least one embodiment, the processing device 102 can receive power consumption data 101 for the computing device 116 from a service processor 130 of an rPDU 128, which is coupled to power the computing systems 114(1)-114(N) of the rack 112. The rPDU 128 can include a power outlet coupled to a power cable between the computing system 114(1) and the rPDU 128. The rPDU 128 can include additional power outlets in which power cables for the other computing systems 114(2)-(N) can be plugged. The rPDU 128 can distribute power from a power source to one or more computing systems 114 in the rack 112. The rPDU 128 can monitor, manage, and control power consumption to multiple computing devices 116(1)-(N) in the data center 110. The service processor 130 can be accessed over a local network or remotely via a network connection 132. The processing device 102 can store the collected power consumption data in the data store 106. The processing device 102 can determine a set of features from the power consumption data 101 for a first time period. The processing device 102 can classify whether the computing device 116 is idle (or underutilized) or busy in the first time period using the ML model 104 and the set of features. The processing device 102 can output an indication of the computing device 116 being idle, responsive to a classification that the computing device 116 is idle. The processing device 102 can send the idle indication to a client device 124, such as to be displayed on a user interface (UI) dashboard 126. In at least one embodiment, the processing device 102 provides a UI dashboard 126 with the indication on the client device 12. In some embodiments, the rack 112 includes both service processor 130 and service processor(s) 120 associated with the computing device(s) 116). In some embodiments, the rack 112 includes only the service processor 130 or the service processor(s) 120 associated with the computing device(s) 116).

In at least one embodiment, the idle-device identification system 100 does not incur the overhead costs of running an agent or process within the OS because the idle-device identification system 100 does not use an agent or a process to collect the power consumption data. In at least one embodiment, the idle-device identification system 100 does not include the risk of the agent or process being terminated or stopped by administrators because the idle-device identification system 100 does not use an agent or a process to collect the power consumption data. In at least one embodiment, the idle-device identification system 100, instead of collecting metric information in an intrusive way by an agent or process in the OS, can collect power consumption information non-intrusively from a computing device 116 that is determined to be idle using the ML model 104.

In another embodiment, the data center 110 can include additional racks that each include an rPDU and one or more computing system 114 similar to the rPDU 128 and the computing systems 114(1)-(1)N of rack 112.

In at least one embodiment, the power consumption data includes power measurements. The power measurements can be raw, aggregated, or statistical metrics of multiple power measurements. For example, the power measurements can be aggregated as a maximum power, a minimum power, and an average power for the computing device 116 for a specified time period. In at least one embodiment, the idle-device identification system 100 can determine, from the power measurements, a first set of metrics for the first time period. The first set of metrics can include at least one of a maximum power consumption value, a minimum power consumption value, or an average power consumption value for the first time period. In at least one embodiment, the idle-device identification system 100 can determine a first set of features from the first set of metrics. In a further embodiment, the idle-device identification system 100 can determine a device type of the computing device 116 (e.g., CPU, GPU, SoC, or DPU). The feature set can include the device type. In at least one embodiment, the feature set includes a CPU type and a GPU type when the computing device 116 includes both a CPU and a GPU. In at least one embodiment, the idle-device identification system 100 can determine, from the power measurements, a first set of metrics for the first time period and a second set of metrics for a second time period. The first set of metrics can include at least one of a maximum power consumption value, a minimum power consumption value, or an average power consumption value by the computing device 116 for the first time period. The second set of metrics can include at least one of a maximum power consumption, a minimum power consumption value, or an average power consumption value by the computing device 116 for the second time period. In at least one embodiment, the idle-device identification system 100 can aggregate the first set and the second set of metrics into the set of features to be input into the ML model 104. In another embodiment, the processing device 102 can perform other operations before inputting the features in the ML model 104.

In at least one embodiment, the processing device 102 sends a command to the service processor 120 (or 130). The command includes a request for the power consumption data 101 for a specified period of time. In at least one embodiment, the command is an IPMI command. In at least one embodiment, the command is a PDU command. In at least one embodiment, the idle-device identification system 100 can request the power consumption data 101 periodically from the service processor 120 (or 130) or a service that aggregates the power measurements, such as described below with respect to FIG. 1B.

FIG. 1B is a block diagram of an idle-device identification system 100 for collecting power information non-intrusively from a data center, according to at least one embodiment. The idle-device identification system 100 includes a collection service 140 for collecting the power information for one or more computing devices in the data center 110. In at least one embodiment, the collection service 140 is executed by the processing device 102 of FIG. 1A. In another embodiment, the collection service 140 is executed by a processing device separate from the processing device 102, such as when the processing device 102 is an endpoint device at which the ML model 104 is deployed. In at least one embodiment, the collection service 140 is used by the idle-device identification system 100 for collecting power consumption information for training the ML model 104 and for classification by the ML model 104 after training. In at least one embodiment, the collection service 140 is implemented in an instrumented server to collect power measurements from the service processor at a specified interval and aggregate this data as specific metrics, such as maximum power consumption value for a given period (e.g., each hour of a given date), minimum power consumption value for the given period, and average power consumption value for the given period. Alternatively, other power metrics can be used for one or more periods.

In at least one embodiment, the collection service 140 uses commands 141 (e.g., IPMI commands or PDU commands) to fetch the power consumption data about the computing device of the data center 110. In at least one embodiment, the IPMI commands can poll the BMC associated with the computing device. As described above, because the BMC is independent of the OS running on the computing device, the collection service 140 collects the power consumption information in a non-intrusive manner and does not impact user processes or performance of the computing device.

In other embodiments where consumption information is not fetched using IPMI commands or IPMI is not configured, the collection service 140 can collect the power consumption information from the rPDU 128 using PDU commands.

In at least one embodiment, sample commands of one of the commands 141 can be as follows:

IPMI Command:
ipmi-dcmi --session-timeout=6000 -D LAN_2_0 -h HOST_NAME -u USER_ID -p
IPMI_PASSWORD --get-system-power-statistics
PDU Command:
snmpget -v 2c -c public PDU_ HOST OUTLET_NUMBER

Alternatively, other commands can be used for the commands 141 to collect the power consumption information from the service processor (120 or 130).

The collection service 140 can fetch and store power consumption data 101 in the data store 106. The power consumption data 101 can include historical power consumption data used for training the ML model 104 or power consumption data used for classification by the ML model 104 once deployed. In at least one embodiment, the idle-device identification system 100 can analyze the power consumption information stored in the data store 106 using ML techniques to train the ML model 104. The ML model 104 can be used to determine whether a computing device is a computing device is idle or busy.

In at least one embodiment, once the power consumption information is collected by the collection service 140, the collection service 140 (or a separate aggregation service (not illustrated in FIG. 1B)), can aggregate the data for a specified time period (e.g., each hour for a given day). The processing device 102 uses the aggregated data to train the ML model 104 and for feature sets to be input into the trained ML model 104 to classify a computing device as idle or busy as described herein.

In at least one embodiment, the collection service 140 can collect the power consumption data using IPMI commands at every fixed internals (e.g., 30 seconds) and store the power consumption data in database tables of a database (e.g., data store 106). The collection service 140 (or a separate service) can aggregate the power consumption data for a specified time period (e.g., each hour of a given day) and summarize usage data in a summary table, such as shown in an example summary table, Table 1.

TABLE 1

| | | | | |
|---|---|---|---|---|
| | 1^{st} Time Period (e.g., 1^{st} hour) | 2^{nd} Time Period (e.g., 2^{nd} hour) | ... | N^{th} Time Period (e.g., N^{th} hour) |
| Device 1 | Max power = a1 | Max power = a2 | ... | Max power = aN |
| | Min power = b1 | Min power = b2 | | Min power = bN |
| | Ave. power = c1 | Ave. power = c2 | | Ave. power = cN |
| Device 2 | Max power = a1 | Max power = a2 | ... | |
| | Min power = b 1 | Min power = b2 | | |
| | Ave. power = c1 | Ave. power = c2 | | |
| ... | ... | ... | ... | ... |
| Device M | Max power = a1 | Max power = a2 | | Max power = aN |
| | Min power = b1 | Min power = b2 | | Min power = bN |
| | Ave. power = c1 | Ave. power = c2 | | Ave. power = cN |

In at least one embodiment, once the power consumption data for all of the computing devices being monitored is collected, the idle-device identification system 100 can use the power consumption data in the summary table to train the ML model 104 using various machine learning techniques to predict whether computing devices are idle or not.

In at least one embodiment, a system includes a memory device and a processing device operatively coupled to the memory device. The processing device receives power consumption data for a computing device from a service processor operatively coupled to the computing device. The processing device determines a set of features from the power consumption data for a first time period. The processing device classifies, using a ML model and the set of features, whether the computing device is idle or busy in the first time period. The processing device outputs an indication of the computing device being idle responsive to a classification that the computing device is idle. In at least one embodiment, the system include one or more of a control system for an autonomous or semi-autonomous machine; a perception system for an autonomous or semi-autonomous machine; a system for performing simulation operations; a system for performing deep learning operations; a system for generating synthetic data; a system for generating multi-dimensional assets using a collaborative content platform; a system implemented using an edge device; a system implemented using a robot; a system incorporating one or more virtual machines (VMs); a system implemented at least partially in a data center; or a system implemented at least partially using cloud computing resources.

In another embodiment, a processor includes one or more processing units to determine a set of features from power consumption data for a first time period, classify whether a first computing device is idle or busy in the first time period using a ML model and the set of features, and output an indication of the first computing device being idle responsive to a classification that the first computing device is idle. The set of features is determined based on power consumption data corresponding to the first computing device and provided by a second computing device operatively coupled to the first computing device.

In at least one embodiment, the power consumption data includes a set of power measurements. the one or more processing units are to determine the set of features by determining, from the set of power measurements, a first set of metrics for the first time period. The first set of metrics includes at least one of a maximum power consumption value, a minimum power consumption value, or an average power consumption value by the computing device for the first time period. The set of features includes the first set of metrics. In another embodiment, the set of features include a device type of the first computing device.

In another embodiment, the power consumption data includes a set of power measurements. The one or more processing units determine the set of features by determining, from the set of power measurements, a first set of metrics for the first time period. The first set of metrics includes at least one of a first maximum power consumption value, a first minimum power consumption value, and a first average power consumption value by the computing device for the first time period. The one or more processing units determine, from the set of power measurements, a second set of metrics for a second time period. The second set of metrics includes at least one of a second maximum power consumption value, a second minimum power consumption value, or a second average power consumption value by the computing device for the second time period. The one or more processing units aggregate the first set of metrics and the second set of metrics into the set of features.

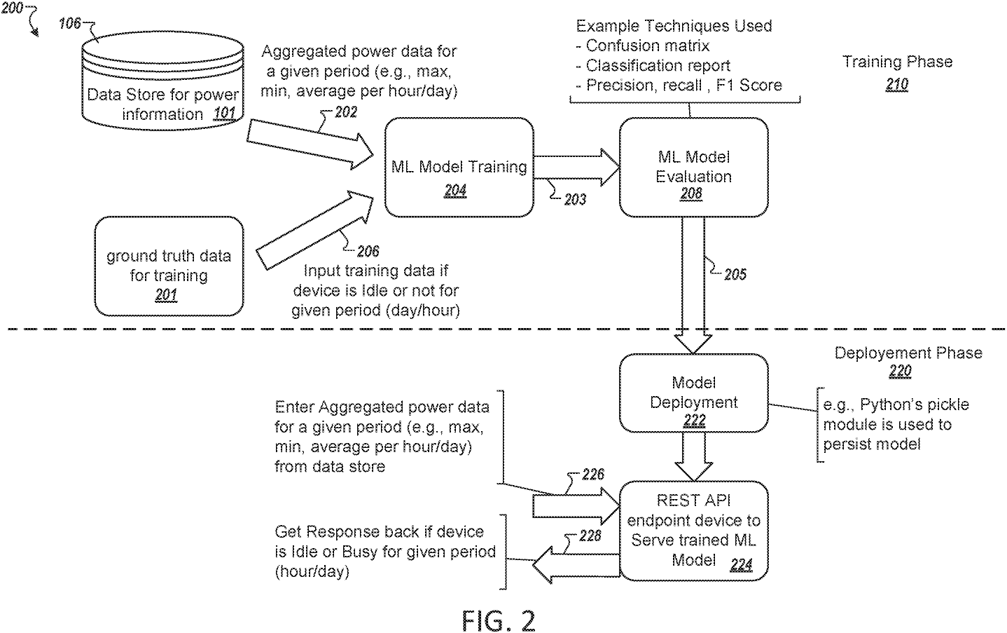

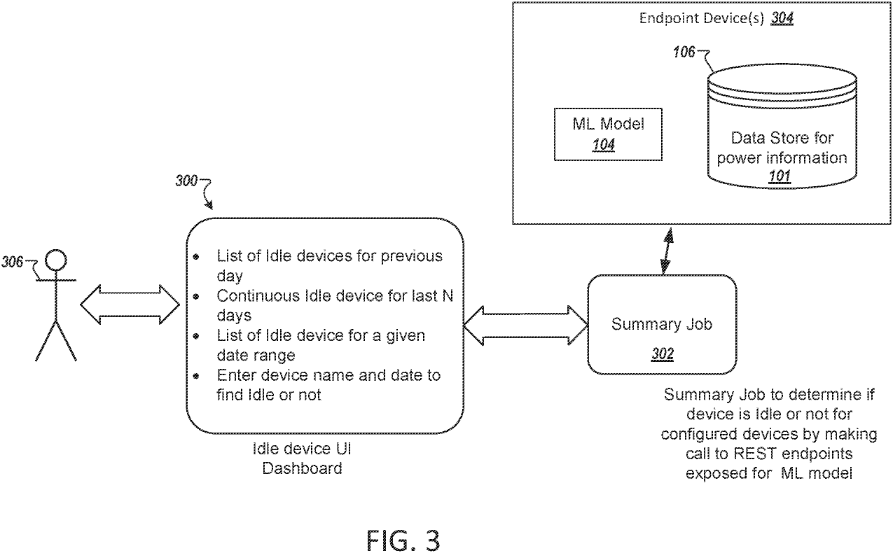

Referring back to FIG. 1A, in at least one embodiment, the processing device 102 can collect and store historical power consumption data in the data store 106 and use the historical power consumption data to train the ML model 104 to classify the computing device 116 as idle or busy using features extracted from the power consumption data 101. The ML model 104 can identify various hidden patterns in the historical power consumption data and use a current pattern in newly collected power consumption data 101 to determine if the computing device 116 is idle or busy. In at least one embodiment, the ML model 104 is trained using historical power consumption data and ground truth data. In at least one embodiment, the ML model 104 may be one or more of a logistics regression model, a k-nearest neighbor model, a random forest classification model, a gradient boost model, or an Extreme Gradient Boost (XGBoost) model. Alternatively, other types of ML models can be used. The trained model 104 can be deployed as an object to an endpoint device having the processing device 102. Additional details of the training and deployment of the ML model 104 are described below with respect to FIGS. 2-3.

FIG. 2 is an example data flow diagram of a process 200 for identifying idle computing devices, according to at least one embodiment. Process 200 can be performed by processing logic comprising hardware, software, firmware, or any combination thereof. The processing logic can be implemented in one or more computing devices, such as a first device for training an ML model and a second device for using the trained mode for classification. In at least one embodiment, process 200 is performed by idle-device identification system 100 of FIGS. 1A-1B. In another embodiment, the process 200 is performed by the processing device 102 of FIG. 1A.

In at least one embodiment, the process 200 includes a pipeline with a training phase 210 and a deployment phase 220. During the training phase 210, the processing logic can perform operations for data preparation of relevant features (e.g., maximum power consumption value, minimum power consumption value, and average power consumption value) for training an ML model. In at least one embodiment, the data store 106 stores the power information collected at configured intervals by the collection service (e.g., instrumented server). In at least one embodiment, the processing logic aggregates the power information into a set of features 202 (e.g., specific power consumption metrics, such as maximum power consumption value for a given period (e.g., each hour of a given date), minimum power consumption value for the given period, and average power consumption value for the given period). The set of features 202 can include device type. The processing logic can collect ground truth data 201. Ground truth data 201 can specify whether the computing device is idle or busy for the given period (e.g., the given hour). The processing logic can input the set of features 202 of a given period and the ground truth data 206 for the given period into the ML model training at block 204.

In at least one embodiment, the ML model training at block 204 can train one or more ML models 203 to be evaluated by the ML model evaluation at block 208. In at least one embodiment, the one or more trained ML models 203 can include one or more of a logistics regression model, a k-nearest neighbor model, a random forest classification model, a gradient boost model, or an XGBoost. Alternatively, other ML models can also be used.

In at least one embodiment, the ML model evaluation at block 208 can evaluate the one or more trained ML models 203. In at least one embodiment, the ML model evaluation techniques can include feature engineering, correlation matrix, hyperparameter tuning, Randomized Search cross-validation (CV), Grid Search CV, feature importance using Mean Decrease in Impurity (MDI), Confusion matrix (Precision, Recall, Accuracy, the weighted average of precision and recall (called F1 score), Receiver Operating Characteristic (ROC) curve, Area under the Curve (AUC), class imbalance (e.g., class_weight to negate the same idle:non-idle with a ratio of 70:30), or the like. Once trained at ML model evaluation block 208, a trained ML model 205 is deployed. The trained ML model 205 is similar to ML model 104 of FIG. 1A.

In at least one embodiment, the machine learning pipeline can include data preparation, ML model training, ML model evaluation, and ML model deployment. As part of the data preparation, the power consumption data is aggregated as feature attributes (e.g., maximum, minimum, and average power for each hour/day of given machines/servers). For the ML model training, the ground truth data along with the feature attributes are used as inputs. For the ML model evaluation, the ML algorithms are evaluated using ML evaluation techniques like the confusion matrix. Key Performance Indicators (KPIs) of the ML algorithm can be used to measure the efficacy of the ML algorithms. For example, precision and recall can be measured as expressed in the following equations:

$$\text{Precision =} \text{TrueIdle} / \left(\text{TrueIdle+FalseIdle}\right) \qquad \text{(1)}$$

$$\text{Recall =} \text{TrueIdle} / \left(\text{TrueIdle+FalseBusy}\right) \qquad \text{(2)}$$

The ML algorithms of the ML model can be further tuned using ML techniques like Hyper-parameter tuning to improve the precision and recall.

Once trained in the training phase 210, the trained ML model 205 can be persisted as an object by serialization/deserialization of the ML model 205 (e.g., using Python Pickle library or other serialization/deserialization technologies) in the deployment phase 220 (block 222). In the deployment phase 220, the object can be deployed to an endpoint device, such as described above as the ML model 104 deployed on the processing device 102 of FIG. 1A (block 224). In at least one embodiment, the object is used to serve the ML model 104 using an interface, such as a representational state transfer application programming interface (REST API). REST API (also known as RESTful API) is an application programming interface (API or web interface) that allows interaction with RESTful web services. In at least one embodiment, the REST APIs are exposed to users (e.g., administrators of the data center 110), where a user can pass the feature attributes for a specified period (e.g., a given hour/day) as input 226. The REST API can return a response 228 with an indication of the computing device being classified as idle or busy for the specified period (e.g., the given hour/day). As described above, aggregated data can be used as inputs to the REST API endpoint for predicting the classification or state (idle or busy) of the computing device for that given period (e.g., idle or busy).

In at least one embodiment, the processing logic can use a summary job to make a call to REST API endpoint devices and store the status (idle or busy) of each configured computing device for each hour/day or other specified time periods. The summary job can use a UI dashboard to provide visualization of the idle devices, such as described below with respect to FIG. 3.

FIG. 3 illustrates an example UI dashboard 300, according to at least one embodiment. A summary job 302 can make calls to endpoint device(s) 304. The endpoint device(s) 304 can use the ML model 104 and aggregated data for features for the ML model based on the power consumption data 101 stored in the data store 106 to determine indications of idle computing devices for a given period (e.g., each hour/day or other specified time periods)

In at least one embodiment, the processing logic can use a summary job to make a call to REST API endpoints and store the status (idle or busy) of each configured computing device for each hour/day (or other specified time periods). The summary job 302 can use a UI dashboard 300 to provide visualization of the idle computed devices. The UI dashboard 300 can include a list of idle devices for a previous day, continuous idle devices for a last N number of days, a list of idle devices for a given data range, or the like. The UI dashboard 300 can also provide a mechanism for a user 306 (e.g., administrator) to enter a device name and specified date/time period to find whether the corresponding computing device is idle or busy.

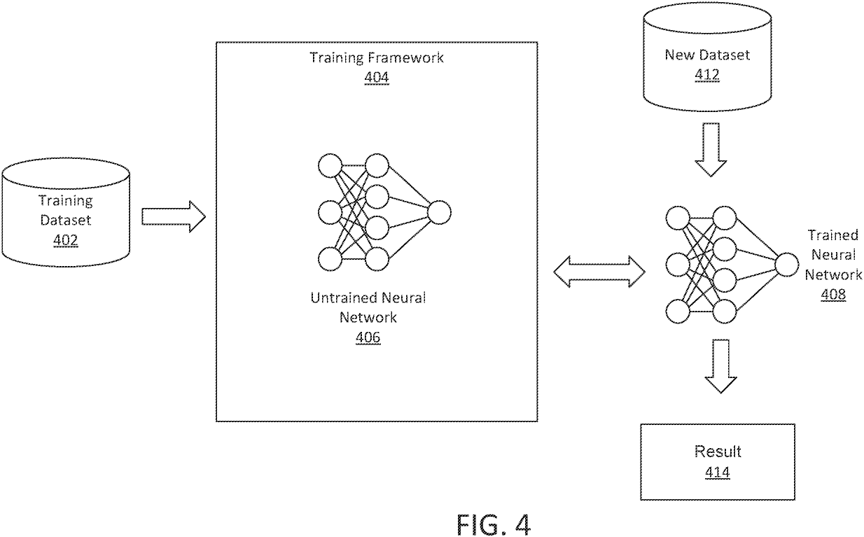

In other embodiments, the ML model can be a neural network, such as a deep neural network. Additional details of neural network training and deployment are described below with respect to FIG. 4.

### Neural Network Training and Deployment

FIG. 4 illustrates training and deployment of a deep neural network, according to at least one embodiment. In at least one embodiment, untrained neural network 406 is trained using a training dataset 402. In at least one embodiment, training framework 404 is a PyTorch framework, whereas in other embodiments, training framework 404 is a TensorFlow, Boost, Caffe, Microsoft Cognitive Toolkit/CNTK, MXNet, Chainer, Keras, Deeplearning4j, or other training frameworks. In at least one embodiment, training framework 404 trains an untrained neural network 406 and enables it to be trained using processing resources described herein to generate a trained neural network 408. In at least one embodiment, weights may be chosen randomly or by pre-training using a deep belief network. In at least one embodiment, training may be performed in either a supervised, partially supervised, or unsupervised manner.

In at least one embodiment, untrained neural network 406 is trained using supervised learning, wherein training dataset 402 includes an input paired with a desired output for an input, or where training dataset 402 includes input having a known output and an output of neural network 406 is manually graded. In at least one embodiment, untrained neural network 406 is trained in a supervised manner and processes inputs from training dataset 402 and compares resulting outputs against a set of expected or desired outputs. In at least one embodiment, errors are propagated back through untrained neural network 406. In at least one embodiment, training framework 404 adjusts weights that control untrained neural network 406. In at least one embodiment, training framework 404 includes tools to monitor how well untrained neural network 406 is converging towards a model, such as trained neural network 408, suitable to generating correct answers, such as in result 414, based on input data such as a new dataset 412. In at least one embodiment, training framework 404 trains untrained neural network 406 repeatedly while adjusting weights to refine an output of untrained neural network 406 using a loss function and adjustment algorithm, such as stochastic gradient descent. In at least one embodiment, training framework 404 trains untrained neural network 406 until untrained neural network 406 achieves a desired accuracy. In at least one embodiment, trained neural network 408 can then be deployed to implement any number of machine learning operations.

In at least one embodiment, untrained neural network 406 is trained using unsupervised learning, wherein untrained neural network 406 attempts to train itself using unlabeled data. In at least one embodiment, unsupervised learning training dataset 402 will include input data without any associated output data or “ground truth” data. In at least one embodiment, untrained neural network 406 can learn groupings within training dataset 402 and determine how individual inputs are related to untrained dataset 402. In at least one embodiment, unsupervised training can be used to generate a self-organizing map in trained neural network 408 capable of performing operations useful in reducing the dimensionality of new dataset 412. In at least one embodiment, unsupervised training can also be used to perform anomaly detection, which allows identification of data points in new dataset 412 that deviate from normal patterns of new dataset 412.

In at least one embodiment, semi-supervised learning may be used, which is a technique in which training dataset 402 includes a mix of labeled and unlabeled data. In at least one embodiment, training framework 404 may be used to perform incremental learning, such as through transferred learning techniques. In at least one embodiment, incremental learning enables trained neural network 408 to adapt to new dataset 412 without forgetting knowledge instilled within trained neural network 408 during initial training.

### Identifying Idle Devices/Machines

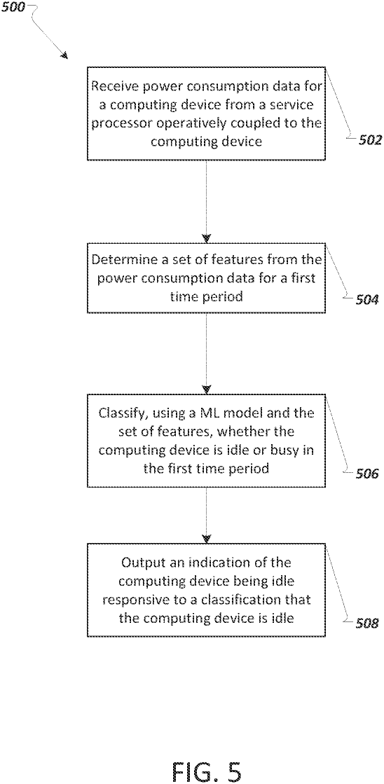

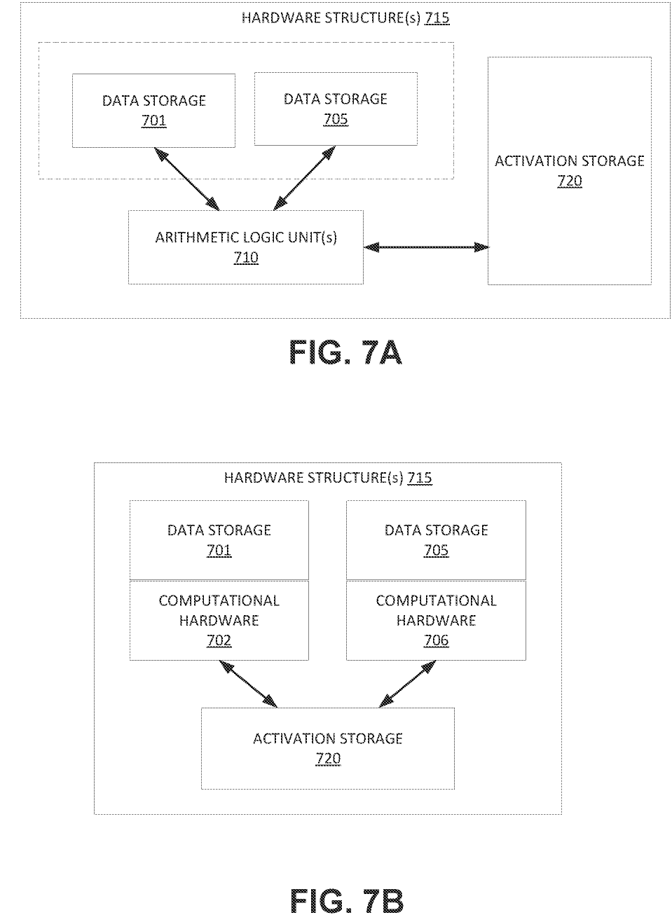

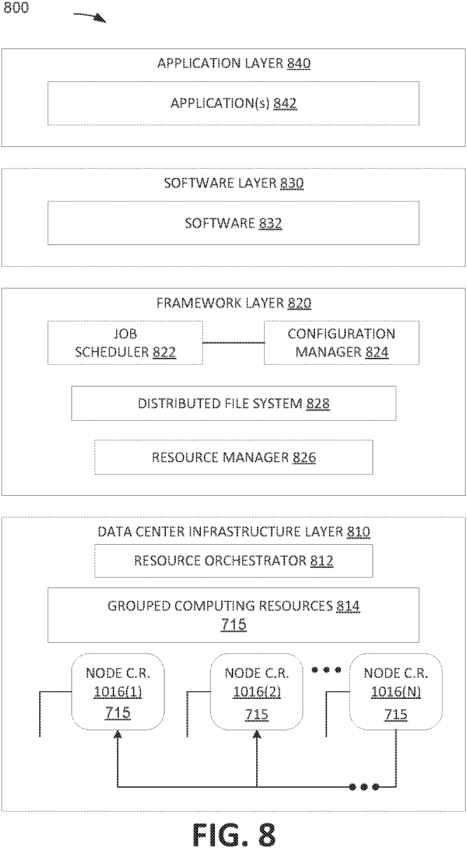

FIG. 5 is a flow diagram of a method 500 of identifying idle computing devices, according to at least one embodiment. Method 500 can be performed by processing logic comprising hardware, software, firmware, or any combination thereof. In at least one embodiment, method 500 is performed by idle-device identification system 100 of FIG. 1A-1A. In another embodiment, method 500 is performed by the processing device 102 of FIG. 1A. In at least one embodiment, method 500 is performed by inference and/or training logic 715. Details regarding inference and/or training logic 715 are provided herein in conjunction with FIGS. 7A and/or 7B.

Referring to FIG. 5, method 500 begins by processing logic receiving power consumption data for a computing device from a service processor operatively coupled to the computing device (block 502). The processing logic determines a set of features from the power consumption data for a first time period (block 504). The processing logic classifies, using an ML model and the set of features, whether the computing device is idle or busy in the first time period (block 506). The processing logic outputs an indication of the computing device being idle responsive to a classification that the computing device is idle (block 508).

In a further embodiment, the power consumption data include multiple power measurements. The processing logic determines the set of features by determining a first set of metrics from the multiple power measurements for the first time period. The first set of metrics includes at least one of a maximum power consumption value, a minimum power consumption value, or an average power consumption value by the computing device for the first time period. In at least one embodiment, the set of features includes the first set of metrics. In at least one embodiment, the set of features includes the first set of metrics and a device type of the computing device. For example, the device type can include a CPU type of a CPU of the computing device and a GPU type of a GPU of the computing device. In at least one embodiment, the set of features includes a device type of either a CPU or a GPU of the computing device.

In a further embodiment, the power consumption data include multiple power measurements. The processing logic determines the set of features by determining, from the multiple power measurements, a first set of metrics for the first time period and a second set of metrics for a second time period. The first set of metrics includes at least one of a first maximum power consumption value, a first minimum power consumption value, and a first average power consumption value by the computing device for the first time period. The second set of metrics includes at least one of a second maximum power consumption value, a second minimum power consumption value, or a second average power consumption value by the computing device for the second time period. The processing logic aggregates the first set of metrics and the second set of metrics into the set of features.

In at least one embodiment, the processing logic sends a command to the service processor. The command can include a request for the power consumption data. In at least one embodiment, the processing logic sends the command periodically to request the power consumption data periodically at fixed intervals.

In another embodiment, the processing logic sends an IPMI command to the service processor, where the service processor is a BMC located on a circuit board of the computing device. In another embodiment, the processing logic sends a PDU command to the service processor, where the service processor is or is part of a PDU. The PDU includes a power outlet coupled to a power cable of the computing device.

In at least one embodiment, the processing logic trains the ML model using historical power consumption data and ground truth data. In at least one embodiment, the processing logic deploys the ML model as an object to an endpoint device. In at least one embodiment, the ML model can be implemented as one or more of a logistics regression model, a k-nearest neighbor model, a random forest classification model, a gradient boost model, an XGBoost model, or the like.

In at least one embodiment, the processing logic provides a UI dashboard. The UI dashboard presents an indication of the computing device being idle. In another embodiment, the processing logic sends a message to an administrator of a data center containing the computing device or an administrator of the computing device.

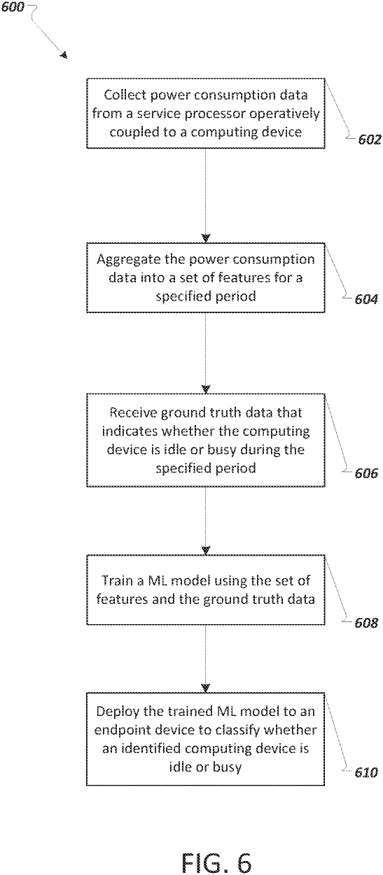

FIG. 6 is a flow diagram of a method 600 of training an ML model for classifying a computing device as idle or busy, according to at least one embodiment. Method 600 can be performed by processing logic comprising hardware, software, firmware, or any combination thereof. In at least one embodiment, method 600 is performed by idle-device identification system 100 of FIG. 1A-1A. In another embodiment, method 600 is performed by the processing device 102 of FIG. 1A. In at least one embodiment, method 600 is performed by inference and/or training logic 715. Details regarding inference and/or training logic 715 are provided herein in conjunction with FIGS. 7A and/or 7B.

Referring to FIG. 6, method 600 begins by processing logic collecting power consumption data from a service processor operatively coupled to a computing device (block 602). The processing logic aggregates the power consumption data into a set of features (block 604). The set of features includes at least a maximum power consumption value, a minimum power consumption value, and an average power consumption value for a specified period. The set of features can also include a device type of the computing device. The processing logic can receive ground truth data that indicates whether the computing device is idle or busy during the specified period (block 606). The processing logic trains an ML model using the set of features and the ground truth data (block 608). The processing logic deploys the trained ML model to an endpoint device to classify whether an identified computing device is idle or busy based on a set of features based on collected power consumption data (block 610).

In a further embodiment, the processing logic receives power consumption data associated with the identified computing device to be classified. The processing logic aggregates the power consumption data into a set of features for a specified period. Using the trained ML model and the set of features, the processing logic classifies whether the identified computing device is idle or busy in the specified period. The processing logic outputs an indication of the identified computing device being idle responsive to a classification that the identified computing device is idle.

### Inference and Training Logic

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor’s L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor’s L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor’s L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a coprocessor). In at least one embodiment, ALUs 710 may be included within a processor’s execution units or otherwise within a bank of ALUs accessible by a processor’s execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor’s L1, L2, or L3 cache or system memory. Furthermore, inferencing and/or training code may be stored with other code accessible to a processor or other hardware logic or circuit and fetched and/or processed using a processor’s fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

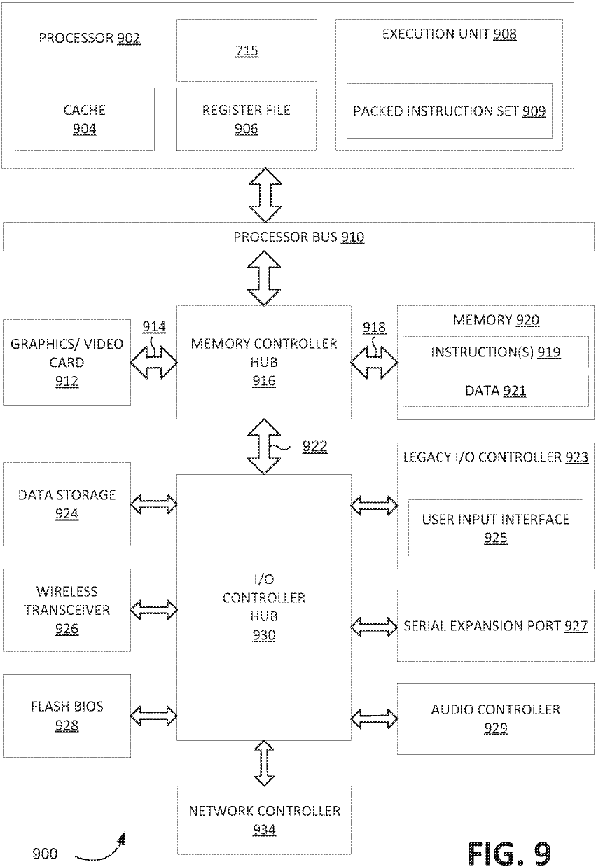

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 822, a configuration manager 824, a resource manager 826, and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache SparkTM (hereinafter “Spark”) that may utilize distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

### Computer Systems

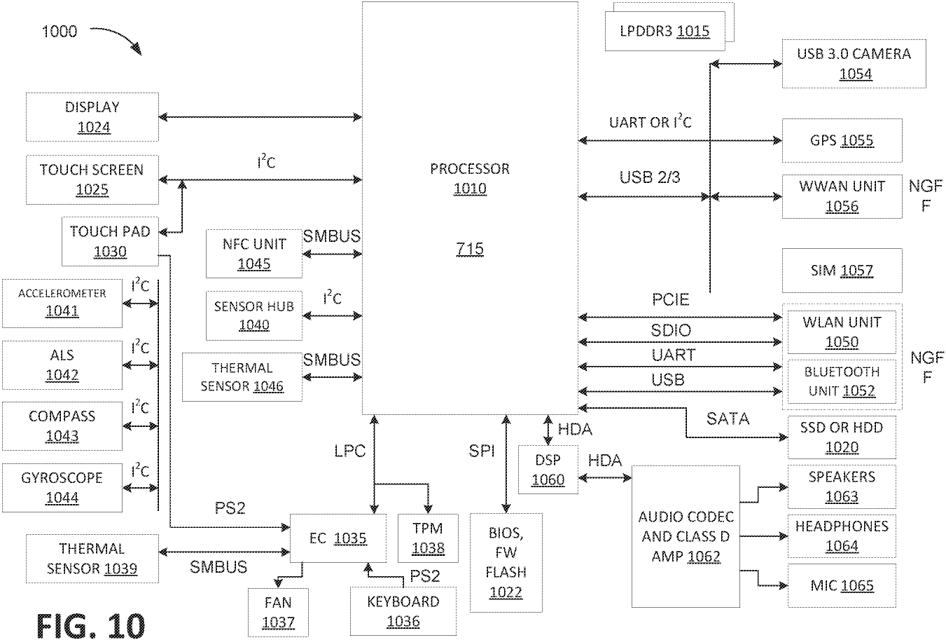

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, XeonTM, Itanium®, XScaleTM and/or StrongARMTM, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS’ operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor’s data bus for performing operations on packed data, which may eliminate need to transfer smaller units of data across processor’s data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips,” whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

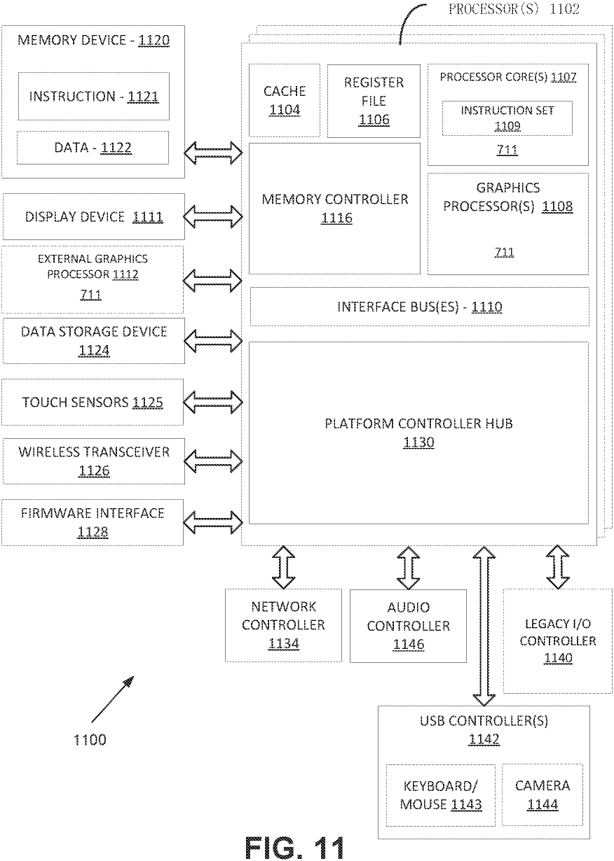

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, system electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips,” whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1046, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to generate synthetic data imitating failure cases in a network training process, which can help to improve performance of the network while limiting the amount of synthetic data to avoid overfitting.

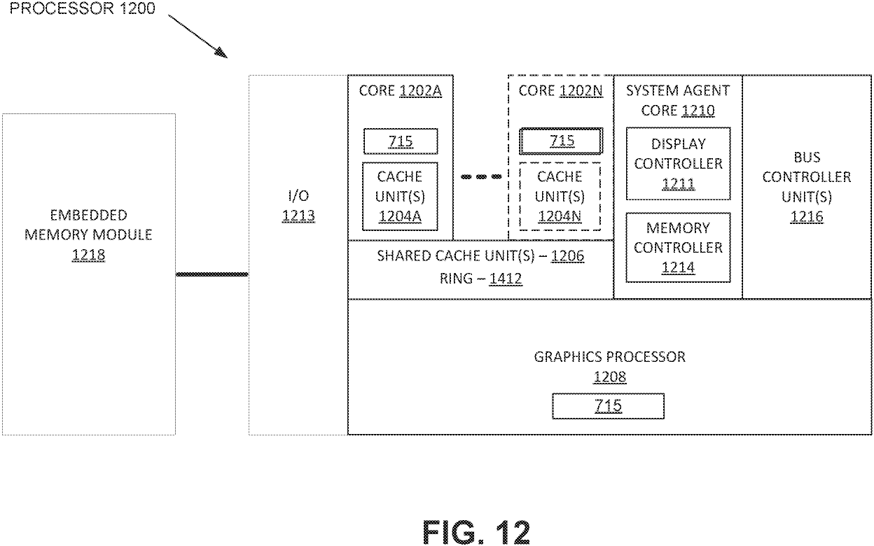

FIG. 11 is a block diagram of a processing system 1100, according to at least one embodiment. In at least one embodiment, processing system 1100 includes one or more processors 1102 and one or more graphics processors 1108, and may be a single processor desktop system, a multiprocessor workstation system, or a server system having a large number of processors 1102 or processor cores 1107. In at least one embodiment, processing system 1100 is a processing platform incorporated within a system-on-a-chip (SoC) integrated circuit for use in mobile, handheld, or embedded devices.

In at least one embodiment, processing system 1100 can include, or be incorporated within a server-based gaming platform, a game console, including a game and media console, a mobile gaming console, a handheld game console, or an online game console. In at least one embodiment, processing system 1100 is a mobile phone, smart phone, tablet computing device or mobile Internet device. In at least one embodiment, processing system 1100 can also include, couple with, or be integrated within a wearable device, such as a smart watch wearable device, smart eyewear device, augmented reality device, or virtual reality device. In at least one embodiment, processing system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor cores 1107 may each process a different instruction set 1109, which may include instructions to facilitate emulation of other instruction sets. In at least one embodiment, processor core 1107 may also include other processing devices, such a Digital Signal Processor (DSP).

In at least one embodiment, processor 1102 includes cache memory 1104. In at least one embodiment, processor 1102 can have a single internal cache or multiple levels of internal cache. In at least one embodiment, cache memory is shared among various components of processor 1102. In at least one embodiment, processor 1102 also uses an external cache (e.g., a Level-3 (L3) cache or Last Level Cache (LLC)) (not shown), which may be shared among processor cores 1107 using known cache coherency techniques. In at least one embodiment, register file 1106 is additionally included in processor 1102, which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in processing system 1100. In at least one embodiment, interface bus 1110, in one embodiment, can be a processor bus, such as a version of a Direct Media Interface (DMI) bus. In at least one embodiment, interface bus 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of processing system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for processing system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus 1110. In at least one embodiment, audio controller 1146 is a multi-channel high definition audio controller. In at least one embodiment, processing system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controllers 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, processing system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1108. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to generate synthetic data imitating failure cases in a network training process, which can help to improve performance of the network while limiting the amount of synthetic data to avoid overfitting.

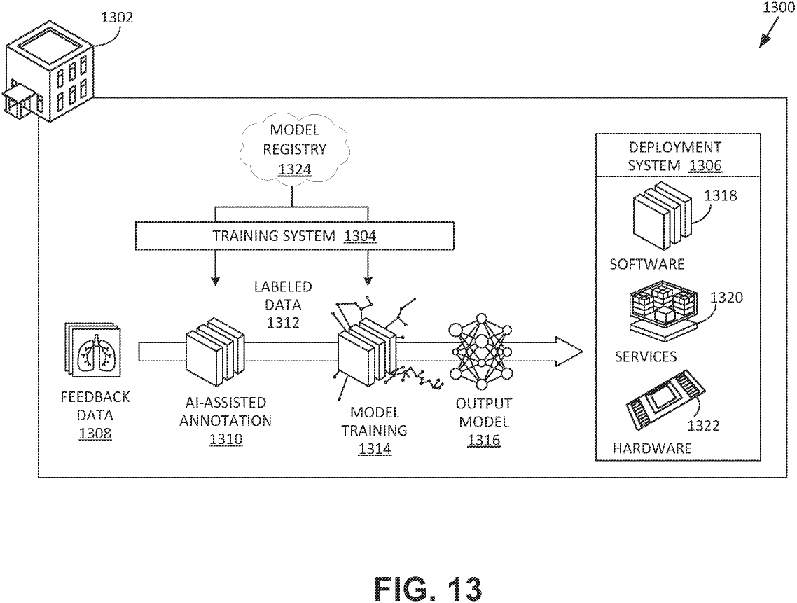

FIG. 12 is a block diagram of a processor 1200 having one or more processor cores 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor cores 1202A-1202N includes one or more internal cache units 1204A-1204N. In at least one embodiment, each processor core also has access to one or more shared cached units 1206.

In at least one embodiment, internal cache units 1204A-1204N and shared cache units 1206 represent a cache memory hierarchy within processor 1200. In at least one embodiment, cache memory units 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor cores 1202A-1202N include support for simultaneous multi-threading. In at least one embodiment, system agent core 1210 includes components for coordinating and operating cores 1202A-1202N during multi-threaded processing. In at least one embodiment, system agent core 1210 may additionally include a power control unit (PCU), which includes logic and components to regulate one or more power states of processor cores 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor cores 1202A-1202N and graphics processor 1208 use embedded memory modules 1218 as a shared Last Level Cache.

In at least one embodiment, processor cores 1202A-1202N are homogenous cores executing a common instruction set architecture. In at least one embodiment, processor cores 1202A-1202N are heterogeneous in terms of instruction set architecture (ISA), where one or more of processor cores 1202A-1202N execute a common instruction set, while one or more other cores of processor cores 1202A-1202N executes a subset of a common instruction set or a different instruction set. In at least one embodiment, processor cores 1202A-1202N are heterogeneous in terms of microarchitecture, where one or more cores having a relatively higher power consumption couple with one or more power cores having a lower power consumption. In at least one embodiment, processor 1200 can be implemented on one or more chips or as a SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A or 7B. In at least one embodiment, weight parameters may be stored in on-chip or off-chip memory and/or registers (shown or not shown) that configure ALUs of processor 1200 to perform one or more machine learning algorithms, neural network architectures, use cases, or training techniques described herein.

Such components can be used to generate synthetic data imitating failure cases in a network training process, which can help to improve performance of the network while limiting the amount of synthetic data to avoid overfitting.

### Virtualized Computing Platform

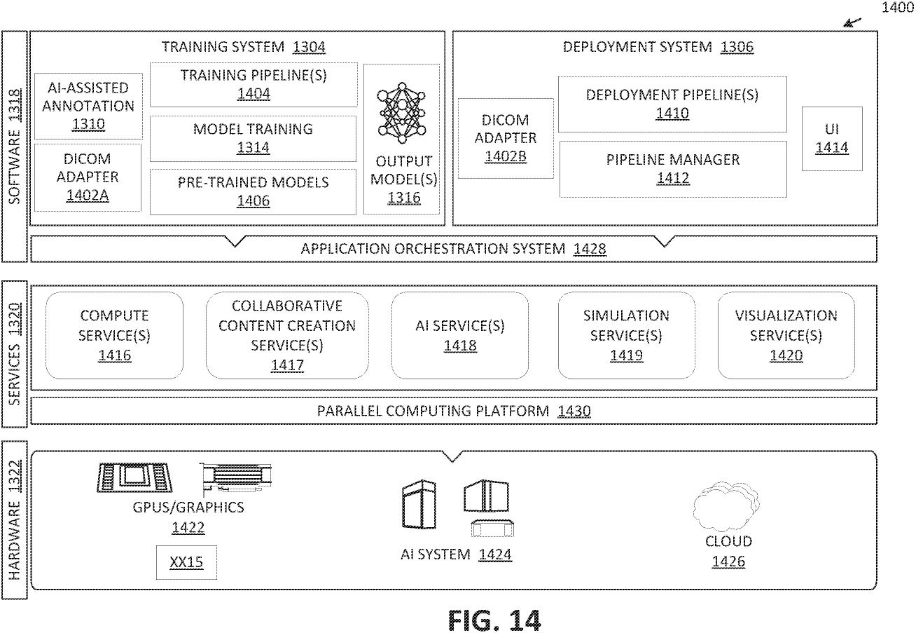

FIG. 13 is an example data flow diagram for a process 1300 of generating and deploying an image processing and inferencing pipeline, in accordance with at least one embodiment. In at least one embodiment, process 1300 may be deployed for use with classifying computing devices, processing devices, and/or other device types at one or more facilities 1302 as idle or busy as described herein.

In at least one embodiment, process 1300 may be executed within a training system 1304 and/or a deployment system 1306. In at least one embodiment, training system 1304 may be used to perform training, deployment, and embodiment of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, deployment system 1306 may provide a streamlined platform for selecting, customizing, and implementing virtual instruments for use with computing devices at facility 1302. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other artificial intelligence (AI) to perform one or more processing steps. In at least one embodiment, machine learning models may be trained at facility 1302 using feedback data 1308 stored at facility 1302 or feedback data 1308 from another facility or facilities, or a combination thereof. In at least one embodiment, training system 1304 may be used to provide applications, services, and/or other resources for generating working, deployable machine learning models for deployment system 1306.

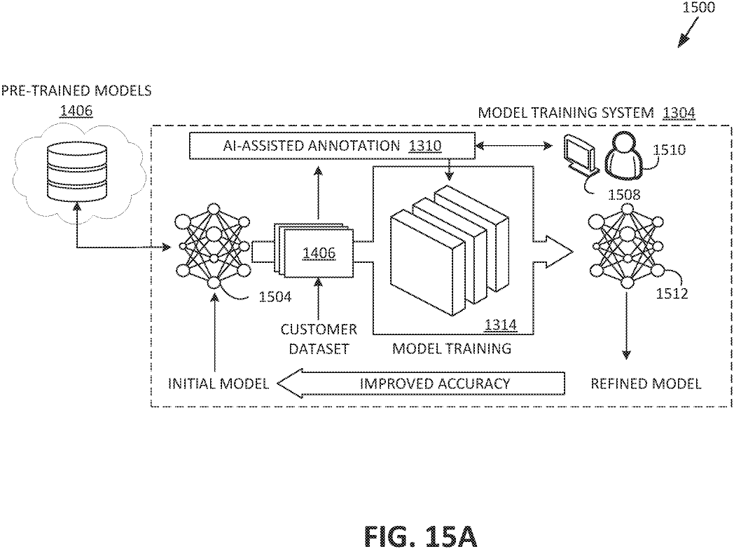

In at least one embodiment, a model registry 1324 may be backed by object storage that may support versioning and object metadata. In at least one embodiment, object storage may be accessible through, for example, a cloud storage (e.g., a cloud 1426 of FIG. 14) compatible application programming interface (API) from within a cloud platform. In at least one embodiment, machine learning models within model registry 1324 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1404 (FIG. 14) may include a scenario where facility 1302 is training their own machine learning model, or has an existing machine learning model that needs to be optimized or updated. In at least one embodiment, feedback data 1308 may be received from various channels, such as forums, web forms, or the like. In at least one embodiment, once feedback data 1308 is received, AI-assisted annotation 1310 may be used to aid in generating annotations corresponding to feedback data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of feedback data 1308 (e.g., from certain devices) and/or certain types of anomalies in feedback data 1308. In at least one embodiment, AI-assisted annotations 1310 may then be used directly, or may be adjusted or fine-tuned using an annotation tool, to generate ground truth data. In at least one embodiment, in some examples, labeled data 1312 may be used as ground truth data for training a machine learning model. In at least one embodiment, AI-assisted annotations 1310, labeled data 1312, or a combination thereof may be used as ground truth data for training a machine learning model, e.g., via model training 1314 in FIGS. 13-14. In at least one embodiment, a trained machine learning model may be referred to as an output model 1316, and may be used by deployment system 1306, as described herein.

In at least one embodiment, training pipeline 1404 (FIG. 14) may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities that are remotely located). In at least one embodiment, machine learning models may have been trained on imaging data from one location, two locations, or any number of locations. In at least one embodiment, when being trained on imaging data, which may be a form of feedback data 208, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained - or partially trained - at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324 - and referred to as output model 1316 - and may be used in deployment system 1306 to perform one or more processing tasks for one or more applications of a deployment system.

In at least one embodiment, training pipeline 1404 (FIG. 14) may be used in a scenario that includes facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 might not be fine-tuned or optimized for feedback data 1308 generated at facility 1302 because of differences in populations, genetic variations, robustness of training data used to train a machine learning model, diversity in anomalies of training data, and/or other issues with training data. In at least one embodiment, AI-assisted annotation 1310 may be used to aid in generating annotations corresponding to feedback data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314 - e.g., AI-assisted annotations 1310, labeled data 1312, or a combination thereof - may be used as ground truth data for retraining or updating a machine learning model.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306.

In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 1308 (or other data types, such as those described herein). In at least one embodiment, an advanced processing and inferencing pipeline may be defined based on selections of different containers that are desired or required for processing feedback data 1308, in addition to containers that receive and configure imaging data for use by each container and/or for use by facility 1302 after processing through a pipeline (e.g., to convert outputs back to a usable data type for storage and display at facility 1302). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1316 of training system 1304.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 14). In at least one embodiment, once validated by system 1400 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1400 of FIG. 14). In at least one embodiment, completed and validated applications or containers may be stored in a container registry and associated machine learning models may be stored in model registry 1324. In at least one embodiment, a requesting entity that provides an inference or image processing request may browse a container registry and/or model registry 1324 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 1306 (e.g., a cloud) to perform processing of a data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, collaborative content creation services, simulation services, AI services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel, e.g., using a parallel computing platform 1430 (FIG. 14). In at least one embodiment, rather than each application that shares a same functionality offered by a service 1320 being required to have a respective instance of service 1320, service 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 1320 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA’s DGXTM supercomputer system), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of game name recognition.

In at least one embodiment, software 1318 and/or services 1320 may be optimized for GPU processing with respect to deep learning, machine learning, and/or high-performance computing, simulation, and visual computing, as non-limiting examples. In at least one embodiment, at least some of the computing environment of deployment system 1306 and/or training system 1304 may be executed in a datacenter or one or more supercomputers or high performance computing systems, with GPU-optimized software (e.g., hardware and software combination of NVIDIA’s DGXTM system). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA’s NGCTM) may be executed using an AI/deep learning supercomputer(s) and/or GPU-optimized software (e.g., as provided on NVIDIA’s DGXTM systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying a deployment pipeline, according to at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a facility, or as a combination of both cloud and local computing resources.. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public internet service providers (ISPs) that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipelines 1410 by deployment system 1306, training pipelines 1404 may be used to train or retrain one or more (e.g., pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, AI-assisted annotation 1310, labeling or annotating of feedback data 1308 to generate labeled data 1312, model selection from a model registry, model training 1314, training, retraining, or updating models, and/or other processing steps. In at least one embodiment, for different machine learning models used by deployment system 1306, different training pipelines 1404 may be used. In at least one embodiment, training pipeline 1404, similar to a first example described with respect to FIG. 13, may be used for a first machine learning model, training pipeline 1404, similar to a second example described with respect to FIG. 13, may be used for a second machine learning model, and training pipeline 1404, similar to a third example described with respect to FIG. 13, may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained model(s) 1406 may include any types of machine learning models depending on embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1404 may include AI-assisted annotation. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 1308 (or other data type used by machine learning models), there may be corresponding ground truth data generated by training system 1304. In at least one embodiment, AI-assisted annotation may be performed as part of deployment pipelines 1410; either in addition to, or in lieu of, AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 1302. In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner.

In at least one embodiment, deployment system 1306 may execute deployment pipelines 1410. In at least one embodiment, deployment pipelines 1410 may include any number of applications that may be sequentially, non-sequentially, or otherwise applied to feedback data (and/or other data types), including AI-assisted annotation, as described above. In at least one embodiment, as described herein, a deployment pipeline 1410 for an individual device may be referred to as a virtual instrument for a device. In at least one embodiment, for a single device, there may be more than one deployment pipeline 1410 depending on information desired from data generated by a device.

In at least one embodiment, applications available for deployment pipelines 1410 may include any application that may be used for performing processing tasks on feedback data or other data from devices. In at least one embodiment, because various applications may share common image operations, in some embodiments, a data augmentation library (e.g., as one of services 1320) may be used to accelerate these operations. In at least one embodiment, to avoid bottlenecks of conventional processing approaches that rely on CPU processing, parallel computing platform 1430 may be used for GPU acceleration of these processing tasks.

In at least one embodiment, deployment system 1306 may include a user interface 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, user interface 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to service 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged and shared by applications or containers in deployment system 1306 may include compute services 1416, collaborative content creation services 1417, AI services 1418, simulation services 1413, visualization services 1420, and/or other service types. In at least one embodiment, applications may call (e.g., execute) one or more of services 1320 to perform processing operations for an application. In at least one embodiment, compute services 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA’s CUDA®) may enable general purpose computing on GPUs (GPGPU) (e.g., GPUs 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1418 may be leveraged to perform inferencing services for executing machine learning model(s) associated with applications (e.g., tasked with performing one or more processing tasks of an application). In at least one embodiment, AI services 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output models 1316 from training system 1304 and/or other models of applications to perform inference on imaging data (e.g., DICOM data, RIS data, CIS data, REST compliant data, RPC data, raw data, etc.). In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI services 1418.

In at least one embodiment, shared storage may be mounted to AI services 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT less than one minute) priority while others may have lower priority (e.g., TAT less than 10 minutes). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization services 1420 may be leveraged to generate visualizations for viewing outputs of applications and/or deployment pipeline(s) 1410. In at least one embodiment, GPUs 1422 may be leveraged by visualization services 1420 to generate visualizations. In at least one embodiment, rendering effects, such as ray-tracing or other light transport simulation techniques, may be implemented by visualization services 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1420 may include an internal visualizer, cinematics, and/or other rendering or image processing capabilities or functionality (e.g., ray tracing, rasterization, internal optics, etc.).

In at least one embodiment, hardware 1322 may include GPUs 1422, AI system 1424, cloud 1426, and/or any other hardware used for executing training system 1304 and/or deployment system 1306. In at least one embodiment, GPUs 1422 (e.g., NVIDIA’s TESLA® and/or QUADRO® GPUs) may include any number of GPUs that may be used for executing processing tasks of compute services 1416, collaborative content creation services 1417, AI services 1418, simulation services 1419, visualization services 1420, other services, and/or any of features or functionality of software 1318. For example, with respect to AI services 1418, GPUs 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs 1422. In at least one embodiment, cloud 1426 may include a GPU-optimized platform for deep learning tasks. In at least one embodiment, AI system 1424 may use GPUs, and cloud 1426 - or at least a portion tasked with deep learning or inferencing - may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA’s DGXTM) may include GPU-optimized software (e.g., a software stack) that may be executed using a plurality of GPUs 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA’s NGCTM) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute services 1416, AI services 1418, and/or visualization services 1420, as described herein. In at least one embodiment, cloud 1426 may perform small and large batch inference (e.g., executing NVIDIA’s TensorRTTM), provide an accelerated parallel computing API and platform 1430 (e.g., NVIDIA’s CUDA®), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

In at least one embodiment, in an effort to preserve patient confidentiality (e.g., where patient data or records are to be used off-premises), cloud 1426 may include a registry, such as a deep learning container registry. In at least one embodiment, a registry may store containers for instantiations of applications that may perform pre-processing, post-processing, or other processing tasks on patient data. In at least one embodiment, cloud 1426 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

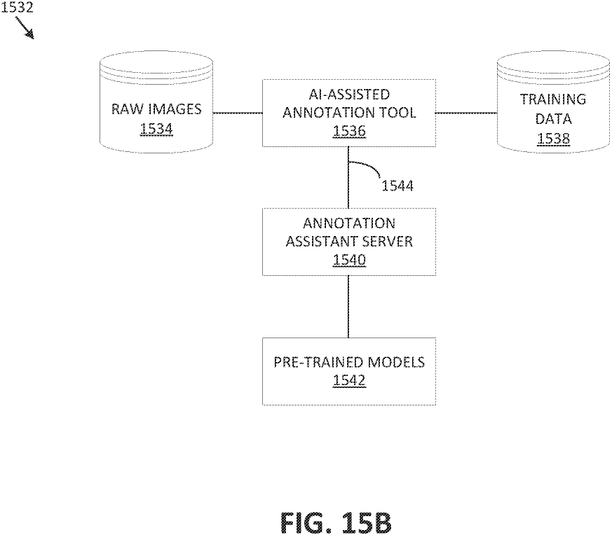

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services 1320 and/or hardware 1322 of system 1400, as described herein. In at least one embodiment, refined models 1512 generated by process 1500 may be executed by deployment system 1306 for one or more containerized applications in deployment pipelines 1410.

In at least one embodiment, model training 1314 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, or deleted, and/or replaced with an updated or new output or loss layer(s). In at least one embodiment, initial model 1504 may have previously fine-tuned parameters (e.g., weights and/or biases) that remain from prior training, so model training 1314 or retraining may not take as long or require as much processing as training a model from scratch. In at least one embodiment, during model training 1314, by having reset or replaced output or loss layer(s) of initial model 1504, parameters may be updated and re-tuned for a new data set based on loss calculations associated with accuracy of output or loss layer(s) at generating predictions on new, customer dataset 1506 (e.g., feedback data 1308 of FIG. 13).

In at least one embodiment, pre-trained models 1406 may be stored in a data store, or registry (e.g., model registry 1324 of FIG. 13). In at least one embodiment, pre-trained models 1406 may have been trained, at least in part, at one or more facilities other than a facility executing process 1500. In at least one embodiment, to protect privacy and rights of patients, subjects, or clients of different facilities, pre-trained models 1406 may have been trained, on-premise, using customer or patient data generated on-premise. In at least one embodiment, pre-trained models 1406 may be trained using cloud 1426 and/or other hardware 1322, but confidential, privacy protected patient data may not be transferred to, used by, or accessible to any components of cloud 1426 (or other off premise hardware). In at least one embodiment, where a pre-trained model 1406 is trained at using patient data from more than one facility, pre-trained model 1406 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1406 on-premise and/or off premise, such as in a datacenter or other cloud computing infrastructure.

In at least one embodiment, when selecting applications for use in deployment pipelines 1410, a user may also select machine learning models to be used for specific applications. In at least one embodiment, a user may not have a model for use, so a user may select a pre-trained model 1406 to use with an application. In at least one embodiment, pre-trained model 1406 may not be optimized for generating accurate results on customer dataset 1506 of a facility of a user (e.g., based on patient diversity, demographics, types of medical imaging devices used, etc.). In at least one embodiment, prior to deploying pre-trained model 1406 into deployment pipeline 1410 for use with an application(s), pre-trained model 1406 may be updated, retrained, and/or fine-tuned for use at a respective facility.

In at least one embodiment, a user may select pre-trained model 1406 that is to be updated, retrained, and/or fine-tuned, and pre-trained model 1406 may be referred to as initial model 1504 for training system 1304 within process 1500. In at least one embodiment, customer dataset 1506 (e.g., imaging data, genomics data, sequencing data, or other data types generated by devices at a facility) may be used to perform model training 1314 (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility (e.g., as labeled clinic data 1312 of FIG. 13).

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, user 1510 may use annotation tools within a user interface (a graphical user interface (GUI)) on computing device 1508.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training 1314 to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines 1410 at a facility for performing one or more processing tasks with respect to medical imaging data.

In at least one embodiment, refined model 1512 may be uploaded to pre-trained models 1406 in model registry 1324 to be selected by another facility. In at least one embodiment, his process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tools 1536 may be instantiated based on a client-server architecture 1532. In at least one embodiment, annotation tools 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation 1310, a deep learning model, for example, may receive this data as input and return inference results of a segmented organ or abnormality. In at least one embodiment, pre-instantiated annotation tools, such as AI-Assisted Annotation Tool 1536B in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines 1404. In at least one embodiment, pre-installed annotation tools may be improved over time as new labeled clinic data 1312 is added.

Such components can be used to generate synthetic data imitating failure cases in a network training process, which can help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors - for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system’s registers and/or memories into other data similarly represented as physical quantities within computing system’s memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
determining, using a processing device, a set of features from power consumption data for a first time period, the power consumption data corresponding to a computing device and being provided using a service processor operatively coupled to the computing device;
classifying, using a machine learning (ML) model and the set of features, whether the computing device is idle or busy in the first time period; and
outputting, using the processing device, an indication of the computing device being idle responsive to a classification that the computing device is idle.

2. The method of claim 1, wherein:
the power consumption data comprises a plurality of power measurements;
determining the set of features comprises determining, from the plurality of power measurements, a first set of metrics for the first time period, the first set of metrics comprising at least one of a maximum power consumption value, a minimum power consumption value, or an average power consumption value by the computing device for the first time period; and
the set of features comprises the first set of metrics.

3. The method of claim 2, wherein the set of features further comprise a device type of the computing device.

4. The method of claim 2, wherein the set of features further comprise a central processing unit (CPU) type of a CPU of the computing device and a graphics processing unit (GPU) type of a GPU of the computing device.

5. The method of claim 1, wherein:
the power consumption data comprises a plurality of power measurements;
determining the set of features comprises determining, from the plurality of power measurements, a first set of metrics for the first time period, the first set of metrics comprising at least one of a first maximum power consumption value, a first minimum power consumption value, and a first average power consumption value by the computing device for the first time period;
determining, from the plurality of power measurements, a second set of metrics for a second time period, the second set of metrics comprising at least one of a second maximum power consumption value, a second minimum power consumption value, or a second average power consumption value by the computing device for the second time period; and
aggregating the first set of metrics and the second set of metrics into the set of features.

6. The method of claim 1, further comprising sending a command to the service processor, the command comprising a request for the power consumption data.

7. The method of claim 1, further comprising:
sending an Intelligent Platform Management Interface (IPMI) command to the service processor, the command comprising a request for the power consumption data, wherein the service processor is a baseboard management controller (BMC) located on a circuit board of the computing device.

8. The method of claim 1, further comprising:
sending a command to the service processor, the command comprising a request for the power consumption data, wherein the service processor is a power distribution unit (PDU) comprising a power outlet coupled to a power cable of the computing device.

9. The method of claim 1, wherein the ML model is trained based on historical power consumption data and ground truth data and is deployed as an object to an endpoint device comprising the processing device.

10. The method of claim 1, further comprising providing a user interface (UI) dashboard, the UI dashboard presenting the indication.

11. The method of claim 1, wherein the ML model is at least one of a logistics regression model, a k-nearest neighbor model, a random forest classification model, a gradient boost model, or an Extreme Gradient Boost (XGBoost) model.

12. A processor, comprising:
one or more processing units to determine a set of features from power consumption data for a first time period, classify whether a first computing device is idle or busy in the first time period using a machine learning (ML) model and the set of features, and output an indication of the first computing device being idle responsive to a classification that the first computing device is idle, wherein the set of features is determined based on power consumption data corresponding to the first computing device and provided by a second computing device operatively coupled to the first computing device.

13. The processor of claim 12, wherein:
the power consumption data comprises a plurality of power measurements;
the one or more processing units are to determine the set of features by determining, from the plurality of power measurements, a first set of metrics for the first time period, the first set of metrics comprising at least one of a maximum power consumption value, a minimum power consumption value, or an average power consumption value by the computing device for the first time period; and
the set of features comprises the first set of metrics.

14. The processor of claim 12, wherein the set of features further comprise a device type of the first computing device.

15. The processor of claim 12, wherein:
the power consumption data comprises a plurality of power measurements;
the one or more processing units are to determine the set of features by determining, from the plurality of power measurements, a first set of metrics for the first time period, the first set of metrics comprising at least one of a first maximum power consumption value, a first minimum power consumption value, and a first average power consumption value by the computing device for the first time period;
the one or more processing units are to determine, from the plurality of power measurements, a second set of metrics for a second time period, the second set of metrics comprising at least one of a second maximum power consumption value, a second minimum power consumption value, or a second average power consumption value by the computing device for the second time period; and
the one or more processing units are to aggregate the first set of metrics and the second set of metrics into the set of features.

16. A system comprising:
a memory device; and
a processing device coupled to the memory device, wherein the processing device is to:
receive power consumption data for a computing device from a service processor operatively coupled to the computing device;
determine a set of features from the power consumption data for a first time period;
classify, using a machine learning (ML) model and the set of features, whether the computing device is idle or busy in the first time period; and
output an indication of the computing device being idle responsive to a classification that the computing device is idle.

17. The system of claim 16, wherein:
the power consumption data comprises a plurality of power measurements;
the processing device, to determine the set of features, is to determine, from the plurality of power measurements, a first set of metrics for the first time period, the first set of metrics comprising at least one of a maximum power consumption value, a minimum power consumption value, or an average power consumption value by the computing device for the first time period; and
the set of features comprises the first set of metrics.

18. The system of claim 17, wherein the set of features further comprise a device type of the computing device.

19. The system of claim 16, wherein:
the power consumption data comprises a plurality of power measurements;
the processing device, to determine the set of features, is to:
determine, from the plurality of power measurements, a first set of metrics for the first time period, the first set of metrics comprising at least one of a maximum power consumption value, a minimum power consumption value, or an average power consumption value by the computing device for the first time period
determine, from the plurality of power measurements, a second set of metrics for a second time period, the second set of metrics comprising at least one of a second maximum power consumption value, a second minimum power consumption value, or a second average power consumption value by the computing device for the second time period; and
aggregate the first set of metrics and the second set of metrics into the set of features.

20. The system of claim 16, wherein the processing device is further to send a command to the service processor, the command comprising a request for the power consumption data.

21. The system of claim 16, wherein the system comprises one or more of:
a control system for an autonomous or semi-autonomous machine;
a perception system for an autonomous or semi-autonomous machine;
a system for performing simulation operations;
a system for performing deep learning operations;
a system for generating synthetic data;
a system for generating multi-dimensional assets using a collaborative content platform;
a system implemented using an edge device;
a system implemented using a robot;
a system incorporating one or more virtual machines (VMs);
a system implemented at least partially in a data center; or
a system implemented at least partially using cloud computing resources.
